(19) United States
(12) Patent Application Publication
(10) Pub. No.: US 2005/0062709 A1
(43) Pub. Date: Mar. 24, 2005

(54) Programmable row selection in liquid crystal display drivers

(76) Inventors: Dominik Zeiter, Schlieren (CH); Adam Smith, Zurich (CH)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/498,447

(22) PCT Filed: Dec. 13, 2002
(86) PCT No.: PCT/IB02/05336

(30) Foreign Application Priority Data
Dec. 14, 2001 (EP) 01129872.6

(51) Int. Cl. G09G 3/36

(52) U.S. Cl. 345/99

(57) ABSTRACT

Liquid crystal display device (100) comprising an LCD display screen (102), column driver means (105), and row driver means (106) with N row slices (63.1, 42.1), whereby N is the number of row electrodes (2) of the LCD display screen (102). Furthermore, the device (100) comprises an input (44) for receiving a set of p orthogonal functions. This input (44) is connected to the column driver means (105) and the row driver means (106). Each row slice (63.1, 42.1) comprises a function selector (63.n) selecting an orthogonal function from the set of p orthogonal functions, and a time-division multiplex decoder (40.n) for transmitting row selection information to the row electrodes (2) depending on a clock signal applied to an input.

The present invention relates to improved drivers for use in liquid crystal displays (LCDs). In particular, the present invention relates the free programmability of the row selection function in display drivers for LCDs.

Today's LCD displays comprise row and column drivers. These drivers typically include a memory unit (e.g., a random access memory (RAM)). The content to be displayed on the LCD screen is shifted into this memory. It is then fetched from the memory using an appropriate addressing scheme and applied to the respective rows and/or columns of the LCD screen.

A standard problem of LCD drivers is the selection of different rows where the data is output on the screen. Scrolling, for example, is an operation that is very complex. Present drivers often only change the read address that is applied to the memory for fetching data from the memory. The order of the display row selection stays mostly unchanged or is very hard to change. Changing the order of the display row selection would require quite a number of multiplexers and wiring. The displaying of RAM data at different locations on the screen is very complex. Especially for multi-row addressing (MRA) this would require a very complex RAM access scheme.

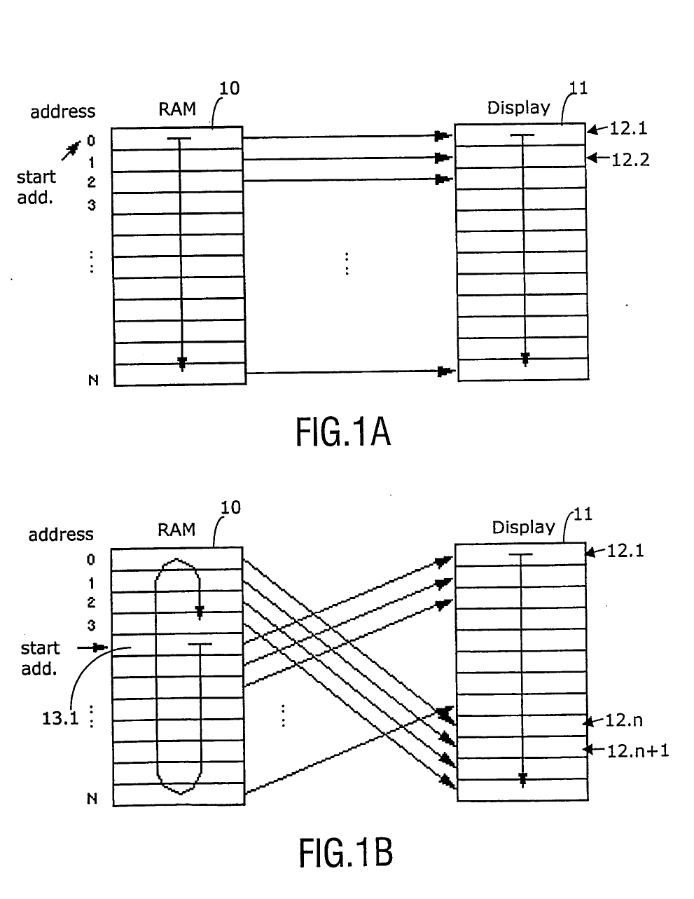

An example of a conventional LCD display driving scheme is illustrated in FIGS. 1A and 1B. In FIG. 1A, a situation is depicted where the content of the RAM cells is fetched by applying appropriate read addresses to the input on the left hand side of the RAM 10. The content of the first RAM cell that is being addressable by applying the start address ‘0’, is applied to the uppermost row 12.1 of the LCD display screen 11. The content of the next RAM cell (address ‘1’) is applied to the second row 12.2, and so forth. If the application program or the user performs a scrolling function on the screen 11, the content of the rows has to be vertically shifted upwards or downwards, depending on the direction of scrolling. An example is shown in FIG. 1B. The content of the RAM cell 13.1 at the start address is displayed at the row 12.1, the content of the next RAM cell is displayed at the next row 12.1+1, an so on. The start address which defines the information being displayed at the first row 12.1. on the LCD screen 11 is now addressing another RAM cell, namely RAM cell 13.1. In other words, in current implementations, the scrolling function is realized by changing the read address of the RAM 10.

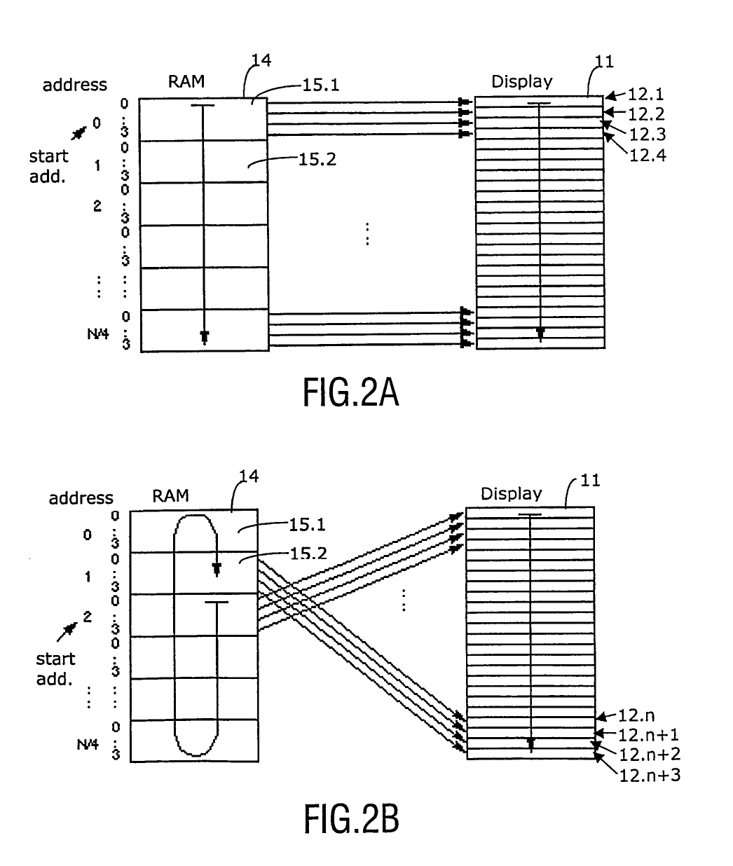

The same principle is illustrated in FIGS. 2A and 2B, with the only difference, that a so-called MRA-scheme is used. In such an MRA implementation, a plurality of LCD rows is addressed at once. As illustrated in FIG. 2A, each RAM cell stores the content of four display rows. By applying the start address ‘0’ to the MRA RAM 14, the content for the rows 12.1 through 12.4. is fetched from the RAM 14. When implementing a scrolling function, as illustrated in FIG. 2B, always four rows are scrolled together. The content of the second RAM cell 15.2 is shifted to the last four rows 12.n through 12.n+3 of the display screen 11. When a freely programmable scrolling is to be implemented using an MRA RAM, a complex RAM addressing scheme or a scheme with multiple RAM access cycles would be required. The scrolling is restricted to a multiple of the number of simultaneously selected rows p (in FIGS. 2A and 2B, p=4).

With the increasing size of the displays the p value increases as well. This in turn decreases the degree of freedom for scrolling. A solution would be to read the RAM in a more complex way. This, however, would require a complex RAM addressing or multiple RAM accesses. The first approach blows up the address decoding by a significant amount. The second approach makes memory necessary after the RAM.

The demand for a reduced power consumption leads to implementations with an adaptable p value, as the optimal p value varies for different multiplex rates.

There is an increasing demand for more freedom and flexibility of addressing the rows of an LCD display screen. This would allow to support such functions as scrolling, freely programmable multiplex rates with freely programmable active areas on the display screen, several active areas on one display screen, mirroring in Y-direction, chip-on-glass (COG) or tape carrier packaging (TCP), and so forth.

It is an object of the present invention to provide a scheme that overcomes the disadvantages of known approaches.

It is an object of the present invention to provide a scheme that allows to write the content of an LCD driver memory to any display row desired.

It is an object of the present invention to provide a scheme that allows a freely programmable selection of rows.

These and other objects are accomplished by a liquid crystal display device comprising an LCD display screen, column driver means, and row driver means with a plurality of row slices. The display device further comprise an input for receiving a set of orthogonal functions, said input being connected to the column driver means and the row driver means. Each row slice comprises a function selector for selecting an orthogonal function from the set of orthogonal functions, and a time-division multiplex decoder for transmitting row selection information to row electrodes of the LCD display screen, depending on a clock signal applied to an input of the time-division multiplex decoder.

According to the present invention the rows can be freely programmed in order to write the RAM content to any display row desired. This invention concerns a scheme that allows to write the content of an LCD driver memory to any display row desired. Furthermore the inventive scheme allows to freely program the selection of rows.

Further advantageous implementations are claimed in claims 2-11.

For a more complete description of the present invention and for further objects and advantages thereof, reference is made to the following description, taken in conjunction with the accompanying drawings, in which:

FIG. 1A is a schematic representation of a conventional display device indicating the relationship between the cells of a RAM and the rows of a display screen;

FIG. 1B is a schematic representation indicating how scrolling by four rows is realized in a conventional display device;

FIG. 2A is a schematic representation of a conventional MRA display device indicating the relationship between the cells of a RAM and the rows of a display screen;

FIG. 2B is a schematic representation indicating how scrolling by eight rows is realized in a conventional MRA display device;

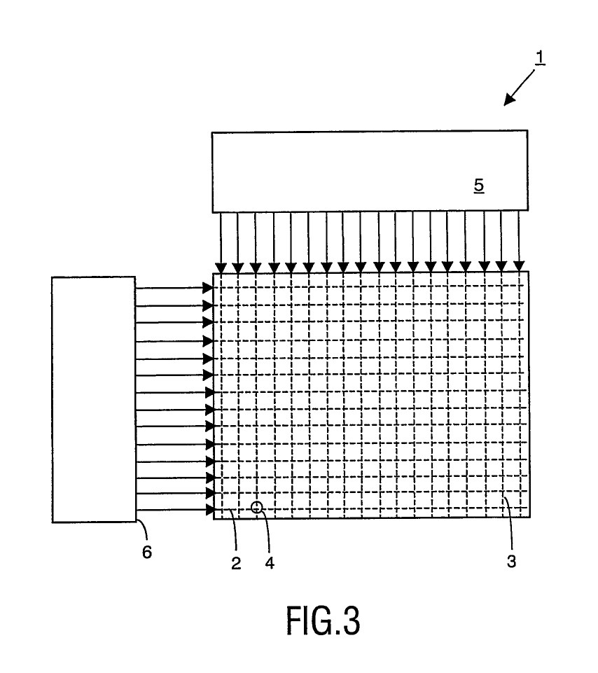

FIG. 3 is a schematic block diagram of a conventional display device;

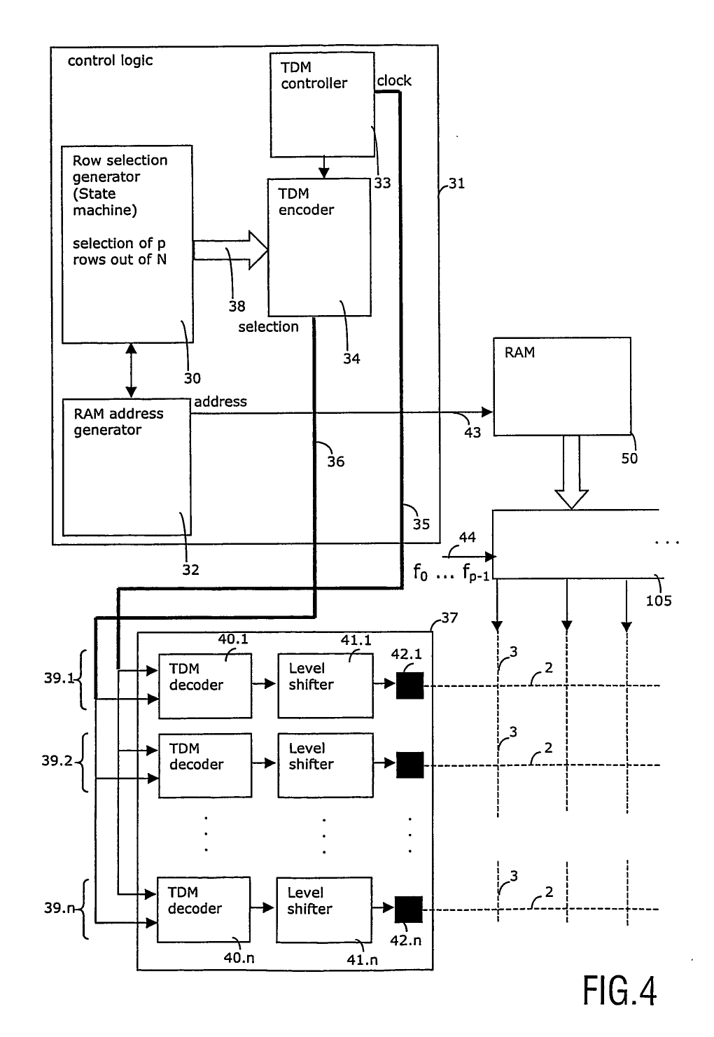

FIG. 4 is a schematic block diagram of part of a display device, according to the present invention;

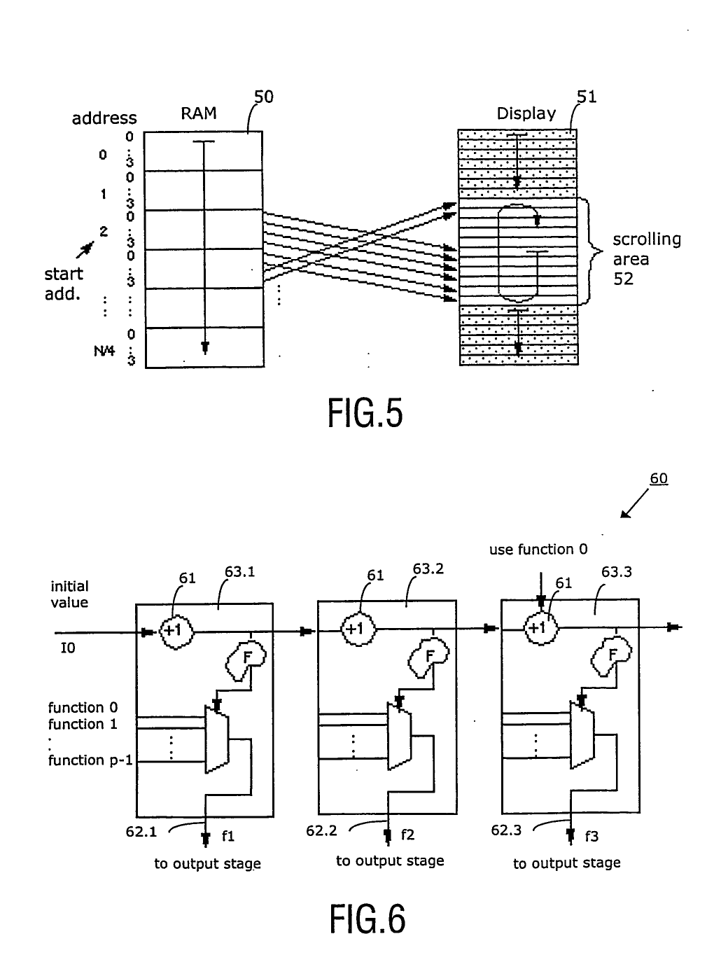

FIG. 5 is a schematic representation indicating how scrolling is realized in an MRA display device (with p=4), according to the present invention;

FIG. 6 is a schematic block diagram of part of a display device, according to the present invention;

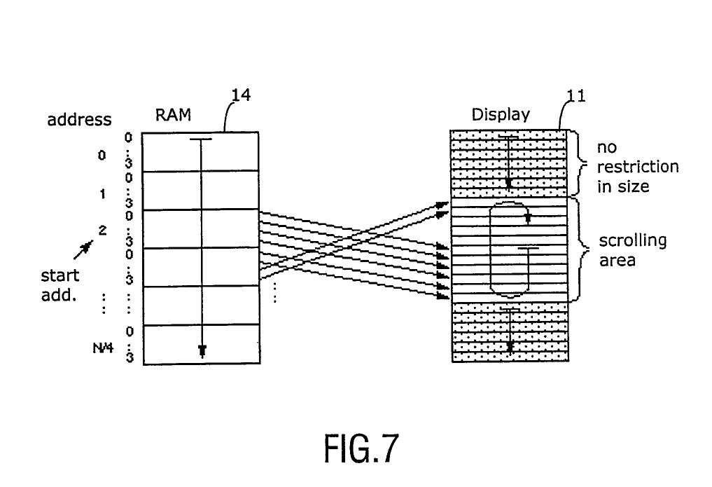

FIG. 7 is a schematic representation indicating how scrolling is realized in display device with four simultaneously selected rows, according to the present invention;

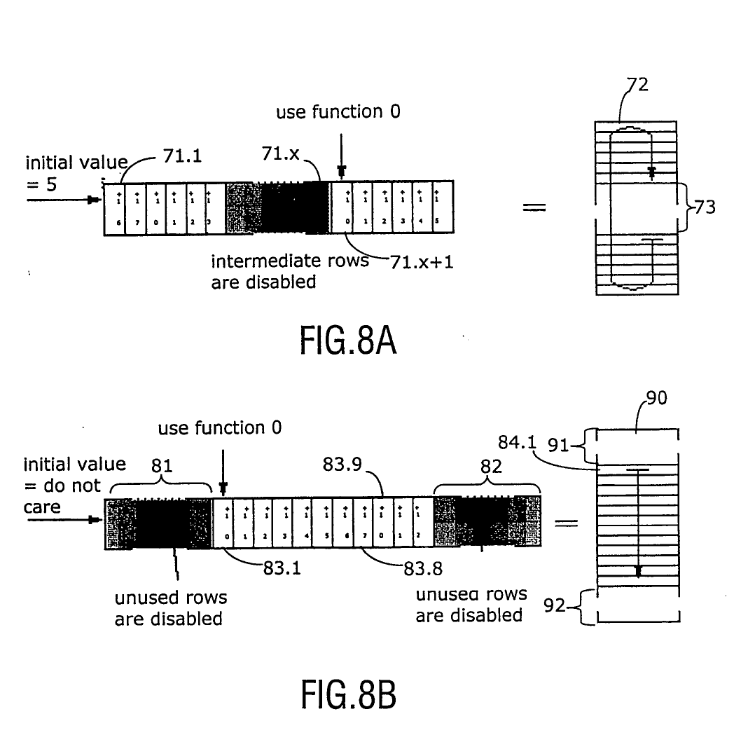

FIG. 8A is a schematic representation of an application example, according to the present invention;

FIG. 8B is a schematic representation of another application example, according to the present invention;

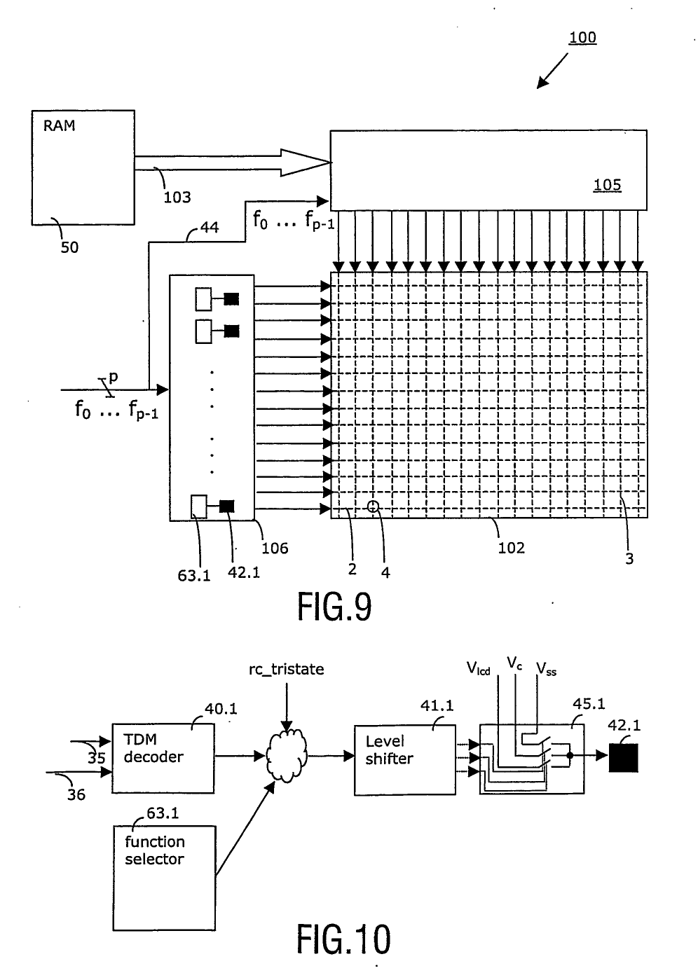

FIG. 9 is a schematic block diagram of a display device, according to the present invention;

FIG. 10 is a schematic block diagram of part of a display device, according to the present invention.

Before addressing various embodiments of the present invention, a brief description of a typical liquid crystal display (LCD) device 1 is given. An LCD device 1, as illustrated in FIG. 3, typically comprises a first substrate provided with row or selection electrodes 2 (shown as horizontal lines) and a second substrate provided with column or data electrodes 3 (shown as vertical lines). The overlapping parts of the row electrodes 2 and column electrodes 3 define pixels 4. In addition, an LCD device 1 comprises drive means 5 for driving the column electrodes 3 in conformity with an image to be displayed, and drive means 6 for driving the row electrodes 2.

According to a first embodiment of the present invention, a state machine 30 is employed, as illustrated in FIG. 4. This state machine 30 is responsible for the sequence of the selection of the rows 2 of a display screen (note that the display screen as such is represented in FIG. 4 by a simple matrix of row electrodes 2 and column electrodes 3). There is a control logic 31 that in addition to the state machine 30 comprises a RAM address generator 32, a time-division multiple (TDM) access controller 33 and a TDM encoder 34. The control logic 31 is connected via a clock bus 35 and a selection bus 36 to the row driver means 37. A TDM scheme is employed to reduce the number of physical bus lines. The data are applied via the selection bus 36 to the individual row slice 39.1-39.n of the row driver means 37 and the clock signal being applied via the clock bus 35 decides which row slice actually handles/processes the data. An address generated by the RAM address generator 32 is applied via a connection 43 to a RAM 50 for retrieval of data. These data are then processed by column driver means 105 together with a set of orthogonal functions Fᵢ{f₀ . . . fₚ₋₁} before being applied to the column electrodes 3 of the display screen. The orthogonal functions are fed via an input 44 to the column driver means 105.

The RAM 50 (cf. FIG. 5) is divided into blocks of p rows, that are always accessed as a whole (p is the number of simultaneously selected rows in the MRA driving technique). That is, each RAM cell stores p data entries. In the present example, p=4 and the start address is 2 (cf. FIG. 5). Therefore only one address for every MRA block of p rows is needed. This makes the RAM decoding much easier and the RAM 50 smaller. To have fill flexibility, the data of a RAM block can be output to any desired p display rows (see FIG. 5 for an example). The rows of the display screen 51 do not have to be adjacent. This is done by the state machine 30 being part of the control logic 31, that can be cut to fit the needs of each chip. The control logic 31 generates a set of p row addresses at an output 38. The row addresses are then encoded and distributed to the row slices 39.1-39.n using a TDM scheme for encoding. Each row slice 39.1-39.n has a TDM decoder 40.n for decoding the TDM signals received, a level shifter 41.n that holds the selection signal for one time slot as only p rows are selected in one time slot. The output signal at the output of the TDM decoders is either 0V or V_{dd}. The level shifters 41.n shift the potential so that it either assumes 0V or V_{lcd}. The level shifters 41.n are connected to the respective row output pads 42.n and the row electrodes 2 of the display screen. Note that p can be any number, i.e., p=1, 2, 3, . . . . The level shifters 41.n and many of the other components are standard components well known in the art.

As illustrated in FIG. 5, with the present invention one can define a scrolling area 52 within the display screen 51. It is possible to freely scroll the rows inside this scrolling area 52. Note that for sake of simplicity the RAM 50 is directly connected to the rows of the display screen 51. In reality, there is no such direct connection since there is at least the column driver means 105 situated between the RAM 50 and the display screen. FIG. 5 shows the logic relationship between RAM cells and the respective rows of the display screen 51.

According to one embodiment, the following driving scheme can be used. The basic idea is to start reading the RAM 50 always at the address ‘0’ and to change the selection of the row dependent on certain programmed settings. When p=8, eight different orthogonal functions Fᵢ={f₀ . . . fₚ₋₁} may be employed. These orthogonal functions Fᵢ are applied to the rows slices of the display screen 51. The selection of the output signals that are applied to the row pads 42.n depend on these orthogonal functions Fᵢ. Each row of the display screen 51 has a corresponding selection signal that tells when the respective row has to be driven at a voltage V_{lcd} or Vₛₛ. All other rows when not being selected are driven at a voltage V_{c}. Note that V_{c}=V_{lcd}/2, where V_{lcd} is the supply voltage of the display screen. The selection of the output signals applied to the row pads 42.n depends on the following three signals (further details are given in connection with FIG. 10):
the orthogonal function Fᵢ (the one function applied to this particular row) switches between V_{lcd} and Vₛₛ;
a selection row signal (row_sel) switches between the selected signal of the orthogonal function Fᵢ and V_{c};
a tristate signal for break before make and for testing (rc_tristate): all switches are open. The rows and columns are multiplexed in blocks and shortened on a tester board. Therefore those row pads 42.n that are not selected must be tristate.

It is thus possible to generate any desired output pattern. The interface between the state machine 30 and the row slices 39.n stays always the same. This allows for an improved re-usability resulting in a shortened time-to-market for LCD products implementing the present invention.

Another embodiment is described in connection with FIGS. 6 and 7. This embodiment is based on an MRA driving technique which asks for a direct correspondence of a function applied to the column electrodes of the display screen and a function applied to the row electrodes, where that data should be displayed. Therefore to have full flexibility one must be able to select which of the p row functions is output at a particular row. A system 60 (cf FIG. 6) is proposed that calculates the selection of the appropriate function out of the number of the function used by its neighbor's output stage. The interconnection between the digital part of the display device and the function selectors 63.n is restricted to an initial value I0 and the information where to start with function 0 (see FIG. 6). The distribution of the orthogonal functions Fᵢ is circular, hence an add-one-circuit 61 can be used in each function selector 63.n to follow this circulation. The add-one-circuit 61 has an override which forces its output to be zero. The function F is used to adapt the count value to the structure of the RAM, where necessary. The outputs 62.1, 62.2, and 62.3 of the function selectors 63.1, 63.2, and 63.3 are connected to the row electrode pads of the display screen (not illustrated in FIG. 6).

Two examples according to the present invention are described below. These two examples are given assuming that a system 60 is employed that uses 8 orthogonal functions Fᵢ. It is only a three bit total, so it rolls over at 7 to 0. The first example is illustrated in FIG. 8A. The initial value I0=5. The add-one-circuit 61 of the first row slice 63.1 add +1 to the initial value. The result (I0+1=6) is given at the bottom of the first box 71.1. This step is repeated in the row slice 63.2 and 7 is obtained as result. The roll over takes place at 7, as mentioned above. This means that the next row slice 63.3 outputs a 0 as result. As illustrated in FIG. 8A, certain intermediate rows are disabled. These rows are shown with a grey background. The row slice 71.x+1 after the one corresponding to the one representing the last intermediate row 71.x starts at 0 again, since the function 0 is applied to its add-one-circuit 61. As schematically illustrated on the right hand side of FIG. 8A, the fact that certain intermediate rows are disabled allows to skip a corresponding area 73 on the display screen 72.

A second example is given in FIG. 8B. In this example there are two areas of row slices 81 and 82 that have been disabled. These two areas 81, 82 correspond to two row blocks 91 and 92 on the screen 90. All rows of these two blocks 91 and 92 are unused in this example. The function 0 defines the first active row slice 83.1 corresponding to the first row 84.1. The add-one-circuit 61 step-by-step adds one to the value until 7 is reached. At the row slice 83.8, the roll over occurs. The next row slice 83.9 start with a value of 0 again.

Another embodiment of a system 100 in accordance with the present invention is shown in FIG. 9. The system 100 comprise row driver means 106 and column driver means 105. Data are taken from a RAM 50 and transferred to the column driver 105 via a bus 103. In order to be able to illuminate the desired pixels 4 of the display screen 102, a set Fᵢ of orthogonal functions f₀ . . . fₚ₋₁ is applied to the row driver means 106 and the column driver means 105 via a line 44. As schematically indicated in FIG. 9, the row driver means 106 comprises an array of p row slices each having at least one function selector 63.n and a row pad 42.n. The function selector 63.n can be similar to the one described in connection with FIG. 6.

Part of another embodiment is illustrated in FIG. 10. This Figure illustrates the relationship between the voltages V_{lcd} and Vₛₛ, the selection row signal (row_sel), and the tristate signal (rc_tristate). The TDM decoder performs a selection of rows depending on the clock signal being applied via a clock bus 35, and the function selector 63.1 provides for a selection of one function out of the set Fᵢ of orthogonal functions f₀ . . . fₚ₋₁. The tristate signal (rc_tistate) is applied for break before make and for testing. The level shifter provides an output signals to transmission gate switches 45.1. The transmission gate switches 45.1 are controlled by the output signals of the level shifter 41.1. At the output of the switches 45.1, one of the following voltages is being made available: V_{lcd} or Vₛₛ or V_{c}.

In the drawings and specification there has been set forth preferred embodiments of the invention and, although specific terms are used, the description thus given uses terminology in a generic and descriptive sense only and not for purposes of limitation.

1. Liquid crystal display device comprising
an LCD display screen,
column driver means,
row driver means having N row slices, whereby N is the number of row electrodes of the LCD display screen,
an input for receiving a set of p orthogonal functions, said input being connected to the column driver means and the row driver means,
whereby each row slice comprises
a function selector selecting an orthogonal function from the set of p orthogonal functions,
a time-division multiplex decoder for transmitting row selection information to the row electrodes depending on a clock signal applied to an input of the time-division multiplex decoder.

2. The device of claim 1, further comprising a control logic.

3. The device of claim 2, wherein the control logic comprises
a state machine serving as row selection generator for the selection of p rows out of the N rows, and
a RAM address generator.

4. The device of claim 3, wherein the control logic comprises a time-division multiple access controller and a time-division multiple access encoder.

5. The device of claim 4, wherein the control logic is connected via a clock bus and a selection bus to the row driver means.

6. The device of claim 1, further comprising a RAM being divided into blocks of p rows.

7. The device of claim 1 being enabled to define a scrolling area within the display screen.

8. The device of claim 1, wherein an driving technique is employed.

9. The device of claim 8, wherein the selection of output signals being applied to the row electrodes depends on the orthogonal function selected from the set of p orthogonal functions.

10. The device of claim 1, wherein the function selectors of the row slices are interconnected so as to be able to calculate the selection of an appropriate orthogonal function out of the number of the orthogonal function used by a preceding function selector.

11. The device of claim 2 being enabled to define that certain intermediate rows are disabled within the display screen.
